(19) United States
(12) Patent Application Publication
(10) Pub. No.: US 2005/0072678 A1
(43) Pub. Date: Apr. 7, 2005

(54) Apparatus for electrophoresis

(76) Inventors: William Hunter, Avalon (AU); Gerard Michael Rummery, Queanbeyan (AU); Benjamin Ross Herbert, North Epping (AU); Matthew C.A. Durack, Glebe (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/490,681

(22) PCT Filed: Sep. 30, 2002
(86) PCT No.: PCT/AU02/01315

(30) Foreign Application Priority Data
Sep. 28, 2001 (AU) PR 8007

(51) Int. Cl. G01N 27/453

(52) U.S. Cl. 204/601; 204/600

(57) ABSTRACT

An apparatus for electrophoresis comprises a base incorporating an integral or separable tray defining a plurality of parallel troughs into which IPG strips may be placed is disclosed. The apparatus further includes a lid. The lid has a top and depending sides and is configured to fit over the base. The lid defines at least one opposed pair of depending electrodes, and also, spaced inwardly of the electrodes relative to the sides of the lid, a pair of opposed depending members for applying pressure to IPG strips located in use, in troughs of the tray. In a variant the lid provides individually addressable electrodes for each of the grooves in the tray wherein the lower edge of the depending electrode bars and the IPG holder bars are all crenellated. In this manner, the lid of the cassette provides an individual pair of opposed electrodes for each of the IPGs running in the tray, and the voltage between each of the pairs of electrodes can be controlled independently of the voltage between other opposed electrode pairs.

### FIELD OF THE INVENTION

This invention relates to an apparatus for use in electrophoresis. In particular the invention relates to a cassette for use in electrophoresis comprising a tray for holding IPG strips and an associated cover, and the use of the same for separating macromolecules by electrophoresis.

### BACKGROUND OF THE INVENTION

In the field of analysing macromolecules, one dimensional and two dimensional gel electrophoresis have become the standard tools for separating and visualising macromolecules. Typical applications of electrophoresis include separating proteins from complex mixtures such as tissue samples, bacteria or plant material. As used herein, the term macromolecule includes but is not limited to proteins including serum and cell proteins, bacterial proteins, non-histone chromatin proteins, ribosomal proteins, mixtures of ribonucleo-proteins and ribosomal proteins, glycoproteins, and nucleic acids. Currently, the highest resolution method for separating macromolecules, is two-dimensional electrophoresis. Typically, such two-dimensional electrophoresis involves sequential separations in a first dimension by isoelectric focusing and in a second dimension by SDS gel electrophoresis. The typical method of performing the first dimension separation, is isoelectric focusing using an electrophoresis gel with an immobilised pH gradient known as an “IPG” or “IPG strip”. These immobilised pH gradients are polyacrylamide gels attached to an activated plastic backing sheet. After the polymerisation process, the plastic sheets, with attached gels, are dried and cut into strips, approximately three millimetres wide. In use, these dry strips are then rehydrated in a protein solution containing the macromolecules which are to be separated and isoelectric focusing is performed on the re-hydrated strip.

Existing two-dimensional electrophoresis systems are labour-intensive and time-consuming to operate. There are problems with the consistent and correct location of electrodes relative to the IPG strip, and with sufficiency of electrical contact between the strip and the electrode, and this leads to inconsistent performance and results.

Thus, to achieve high throughput and reproducibility of sample treatment in the laboratory, it is essential that many of the manual handling steps in the process of analysing macromolecules, are removed as possible, thus, minimising human intervention.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

### SUMMARY OF THE INVENTION

In a first broad aspect of the present invention, there is provided a cassette adapted to hold a tray containing IPG strips.

More particularly the present invention provides an apparatus for carrying out electrophoresis in a tray defining a plurality of parallel troughs into which IPG strips may be placed, the apparatus comprising:—
a base incorporating a tray;
a lid defining a top and depending sides configured to fit over the base characterised in that the lid defines at least one opposed pair of depending electrode bars and spaced inwardly of the electrode bars relative to the sides of the lid, a pair of opposed depending members for applying pressure to IPG strips or the like located in troughs of the tray.

The base preferably defines a frame and the tray may be integral with or separable from the frame.

Typically the frame is generally rectangular and defines four upstanding walls on the top of which the tray may be supported for locating the tray relative to the frame.

Most preferably the frame is open such that the underside of the base of the tray is exposed.

The frame holds the tray in position and the lid of the apparatus/cassette provides the electrodes and associated electrical contacts required for carrying out electrophoresis. The depending members apply pressure to the ends of IPG strips located in troughs of the tray and ensure they make contact with electrode bridges (typically filter paper soaked with electrolyte) located at the ends of the tray.

One advantage of the present invention is that unlike the apparatus described in PCT/AU00/01065, the tray does not require any electrodes as these are provided by the lid of the apparatus/cassette. Since manual placement of the electrodes is not required this enhances the reproducability of the separation process.

The IPG is held in position by the depending bars (IPG holder bars), thus, maintaining positive contact between the IPG and the filter paper, which hence, maintains a consistent electric field through the IPG strip. The apparatus also provides a consistent distance between the IPG strip and the electrode, thus improving reproducability of the system.

It is preferred that the electrode bars and/or IPG holder bars are mounted on biasing means such as springs to ensure positive pressure on the IPG strip and filter paper and to accommodate different thicknesses of filter paper.

It is envisaged that in a modification of the present invention, the lid could be modified to provide individually addressable electrodes for each of the grooves in the tray wherein the lower edge of the depending electrode bars and the IPG holder bars are all crenellated. In this manner, the lid of the cassette provides an individual pair of opposed electrodes for each of the IPGs running in the tray, and the voltage between each of the pairs of electrodes can be controlled independently of the voltage between other opposed electrode pairs.

The tray such as those described in PCT/AU00/01065 in the name of the present applicant, the contents of which are incorporated here by reference, may be used in the apparatus of the present invention. However, the apparatus could be used to accommodate trays running may different types of gels and any open topped type of gel which is not enclosed in glass or plastic plates or the like, such as second dimension type SDS PAGE gel, agarose DNA type gel, starch gels, polyacrylamide carrier ampholyte IEF gels could be used. Such gels could be accommodated in a gel-side-up or a gel-side-down configuration without substantially changing the cassette.

### BRIEF DESCRIPTION OF THE DRAWINGS

Specific embodiments of the invention will now described by way of example only, with reference to the accompanying drawings in which:—

FIG. 1 shows an external view of a first embodiment of an electrophoresis apparatus of the present invention comprising a lid, and an integral tray and base;

FIG. 2 is a longitudinal section through the electrophoresis apparatus of FIG. 1;

FIG. 3 shows the lid of the apparatus of FIG. 1;

FIG. 4 shows the base/tray of the apparatus of FIG. 1;

FIG. 5 is a longitudinal section through base/tray of FIG. 5;

FIG. 6 shows an external view of a second embodiment of an electrophoresis apparatus of the present invention comprising a lid and a base;

FIG. 7 is a longitudinal section through the electrophoresis apparatus of FIG. 6;

FIG. 8 shows the lid of the apparatus of FIG. 6;

FIG. 9 shows the base of the apparatus of FIG. 6;

FIG. 10 shows a tray for use with the apparatus of FIG. 6; and

FIG. 11 shows a modified lid for use with the apparatus of FIG. 1 or 6.

### DETAILED DESCRIPTION OF A PREFERRED EMBODIMENT

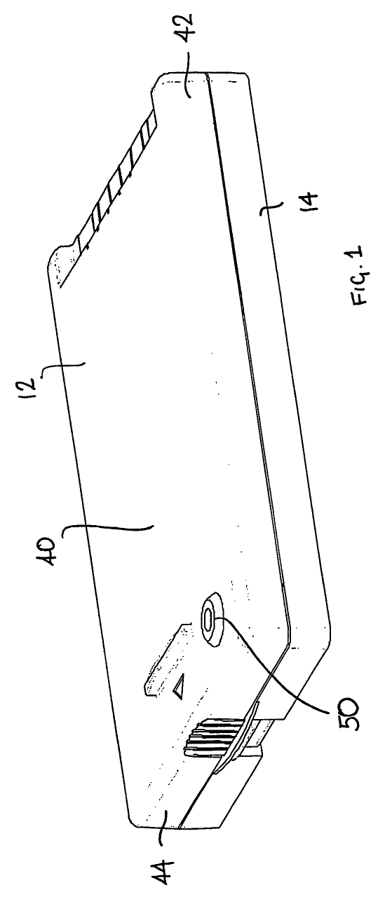

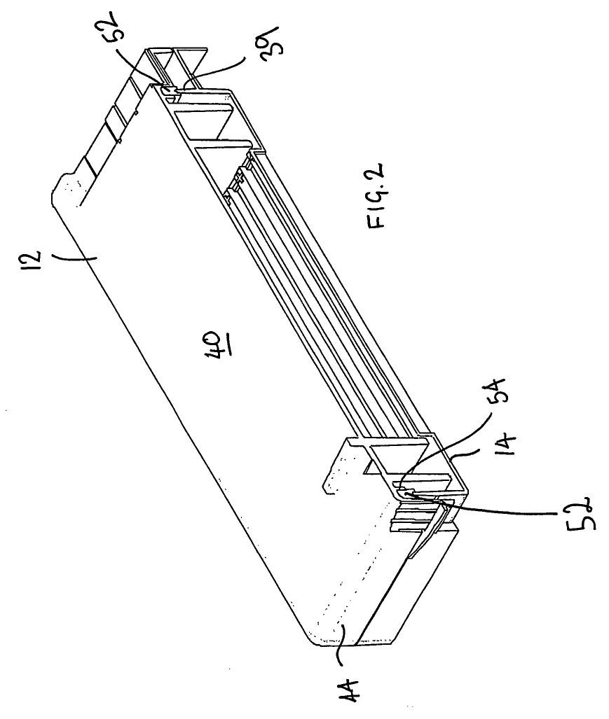

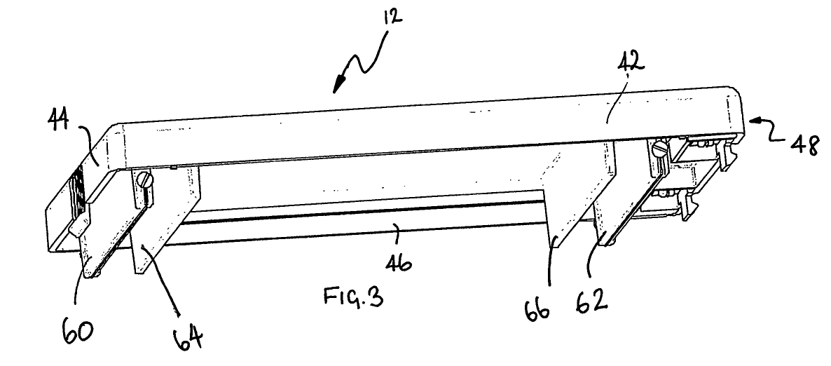

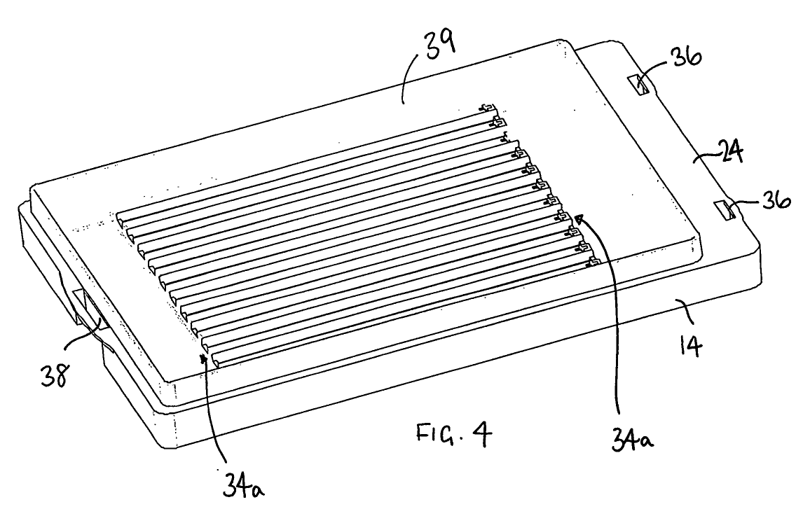

Referring to the drawings, FIGS. 1 to 5 show a first embodiment of a apparatus 10 embodying the present invention. The apparatus includes a lid 12 and a base 14. The base 14 which is best seen in FIGS. 2 and 4 comprises a simple generally rectangular frame defining four sides 16, 18, 20 and 22 and inwardly directed flange 24 extending to an integrally moulded tray 26. The base is typically made in one piece from a moulded plastics material.

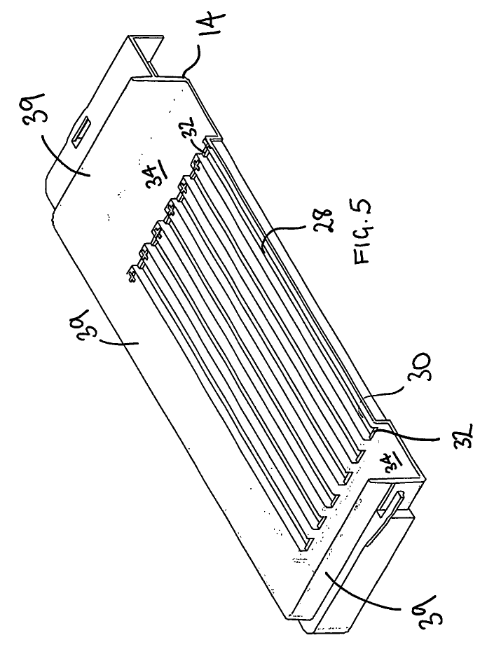

The tray 26 defines twelve elongate parallel grooves or troughs 28. However the tray could have more or less than twelve troughs. The troughs shown in FIG. 4 are about 6 mm wide, however the troughs may be relatively narrower or relatively wider than 6 mm. As is best seen in FIG. 5 each trough 28 has a base or floor 30 which is stepped at each end defining an end wall 32 which serves to contain rehydration fluid for rehydrating an IPG strip within the trough. The wall is about 1 mm above the floor of the trough. There is an electrode bridge region 34 on the opposite side of each wall 32 each of which extends across almost the full width of the tray and is significantly deeper than the troughs. The grooves and electrode bridge regions are surrounded by upstanding walls 39 which define a rectangular open box enclosing the grooves and electrode bridge regions.

As shown in FIG. 4, the inwardly directed flange 24 of the base 14 defines two slots 36 adjacent one end of the tray and one slot 38 adjacent the opposite end of the tray.

The lid 12 as is best seen in FIGS. 1, 2 and 3 defines a top portion 40 which is generally rectangular in plan view and four depending side walls 42, 44, 46 and 48. An aperture 50 is defined in the top of the lid. The aperture is provided for entry of oil (typically paraffin oil or silicon based oil) into the apparatus and a plug, not shown, is provided for sealing the aperture. To ensure that a watertight seal is provided a rubber seal 52 (best seen in FIG. 2) extends around the underside of the lid 40 held between the side walls of the lid and a depending rib 54 spaced from those side walls and when the lid is closed as shown in FIG. 2, the rubber seal engages against the top of the walls 39 of the tray ensuring a watertight seal.

Depending from the underside of the top of the lid are a pair of electrode bars 60, 62. The bars extend parallel to and are located adjacent opposite sides 44 and 48 of the lid. Spaced approximately 20 mm inwards from each of the electrode bars is an IPG holder bar 64, 66 respectively. When the cassette is closed with the tray 11 located in the frame 14, the IPG holder bars are located above the end 34a of the paper interface area of the tray which is proximal to the grooves 28.

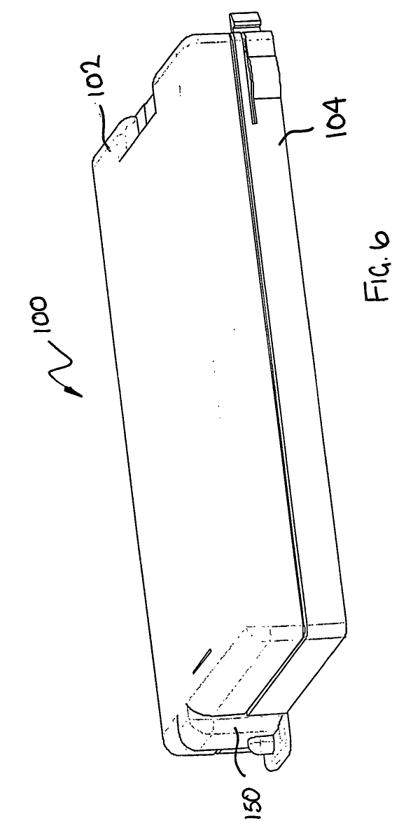

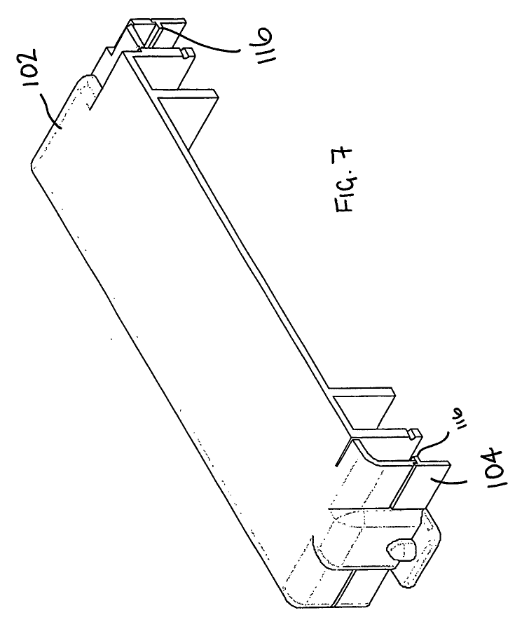

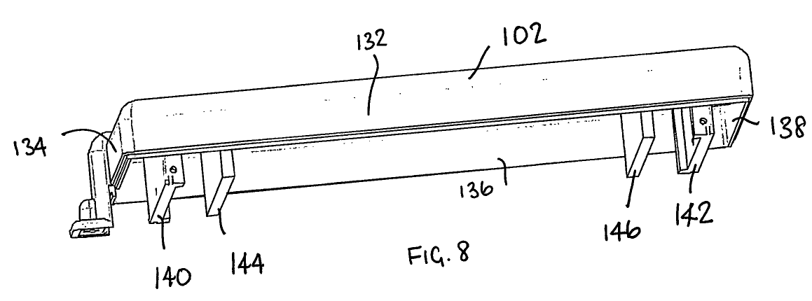

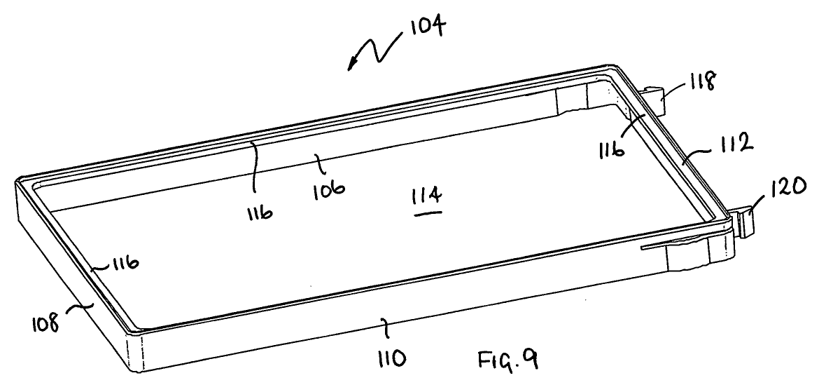

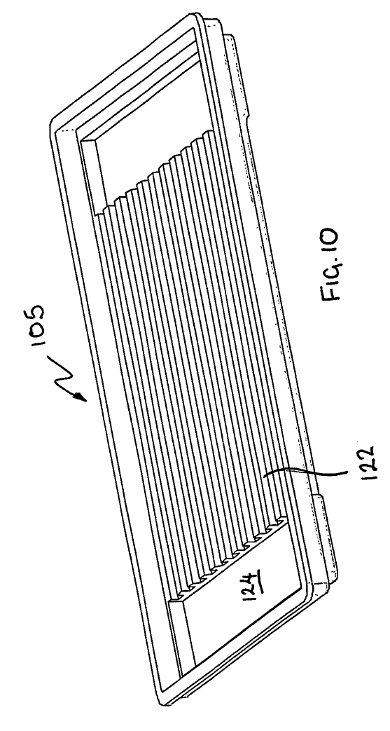

Referring to the drawings, FIGS. 6 to 10 show a second embodiment of an apparatus 100 embodying the present invention comprising a lid 102 and a base 104. In this embodiment the base and tray are not integrally moulded, and the base is in the form of a frame 104 for receiving a separate IPG tray 105 (refer to FIG. 10). The base 104, best seen in FIG. 9, is a simple generally rectangular frame 104 defining four sides 106, 108, 110 and 112 providing an open central area 114. An inwardly extending ledge 116 supports the outer edges of the tray 105 when the tray is located in central area of the frame and holds the tray 105 in the correct position to receive the lid 102. The tray 105 is typically made from a moulded plastics material. The base 104 is open to allow the base of the IPG tray 105 to directly contact a cooling surface, such as a peltier cooling surface or any other suitable cooling surface on which the tray may rest, in use.

Two prongs 118 and 120 extend away from one side 112 of the base which may engage in corresponding recesses defined in a device for running gels to ensure accurate location of the base on the device.

The tray 105 is of essentially the same design as that incorporated into the base of the first described embodiment and defines a series of twelve parallel grooves 122 extending between two relatively wider paper interface areas 124 which extend across almost the full width of the tray and which are significantly deeper than the grooves.

The lid 102 is similar to the lid 12 and has a top portion 130 which is generally rectangular in plan view and four depending side walls 132, 134, 136 and 138. As in the first embodiment, depending from the underside of the top of the lid are a pair of electrode bars 140, 142. The bars extend parallel to and are located adjacent opposite sides 134 and 138 of the lid. Spaced approximately 20 mm inwards from each of the electrode bars is a depending member in the form of an IPG holder bar 144, 146 respectively. When the cassette is closed with the tray 105 located in the frame 104, the IPG holder bars are located above the end 124 of the paper interface area of the tray which is proximal to the grooves 122.

One side of the lid defines a plug element 150 which carries connections to electrodes carries by the electrode bars.

Both the first and second embodiments of the invention are used in much the same way. A sheet of filter paper or the like having a plan size the same as that of the paper interface area 34/124 and a thickness of about 2 mm is placed in the paper interface area. The filter paper contains an electrolyte, typically water. Samples (re-hydration fluid) containing macromolecules to be separated are placed in the grooves and IPG strips are placed gel side down in the grooves/troughs. The IPG strips are slightly longer than the troughs/grooves and project slightly beyond the ends of the troughs. Walls between the paper interface area and the grooves prevent the rehydration fluid from contacting the electrolyte in the manner explained in more detail in PCT/AU00/01065. When the lid is closed over the base 14 or base 104 and tray 105, the IPG holder bars (64, 66; 144, 146) contact the IPG strips and press them onto the filter paper in the paper interface area which is also in contact with the electrode bar. The electrode bar contacts the paper distally from the IPG strip. It is preferred that the electrode bars and/or IPG holder bars are mounted on biasing means such as springs to ensure positive pressure on the IPG strip and filter paper and to accommodate different thicknesses of filter paper.

In the case of the first embodiment, the apparatus may then be filled with paraffin oil and the aperture 50 closed to seal the paraffin in the system. This prevents dust and other contaminants affecting the system and also inhibits condensation. By closing and sealing the electrophoresis experiment being run in the apparatus, the results become less affected by external conditions and are more reliable and easily reproducible. In the second embodiment the tray 105 may also be filled with paraffin oil.

Advantages of this configuration are that there is no manual placement of the electrode required which enhances the reproducability of the separation.

The IPG is held in position by the IPG holder bars, thus, maintaining positive contact between the IPG and the filter paper. This, in turn, maintains a consistent electric field through the IPG strip. The apparatus also provides a consistent distance between the IPG strip and the electrode, thus improving the reproducability of the system.

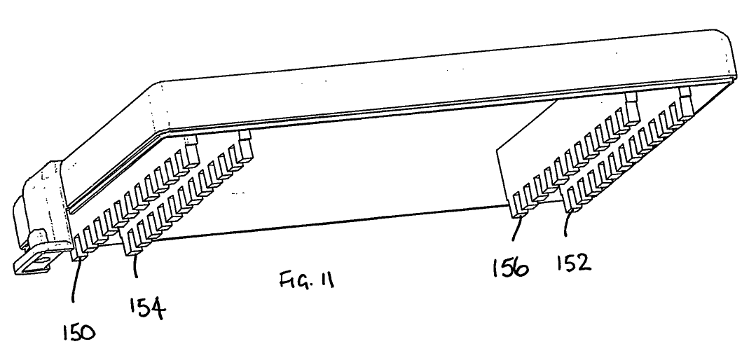

It is envisaged that in a modification of the present invention, the lid could be modified to provide individually addressable electrodes for each of the grooves in the tray. One way of achieving this would be to have a separate power supply for each pair of electrodes. In this embodiment, as shown in FIG. 11, the lower edge of the depending electrode bars 150, 152 and the IPG holder bars 154, 156 are all crenellated. In this manner, the lid of the cassette provides an individual pair of opposed electrodes for each of the IPGs running in the tray, and the voltage between each of the pairs of electrodes can be controlled independently of the voltage between other opposed electrode pairs.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An apparatus for carrying out electrophoresis comprising:
a base incorporating a tray, said tray defining a plurality of parallel troughs for receiving IPG strips; and
a lid defining a top and depending sides configured to fit over the base characterised in that the lid defines at least one opposed pair of depending electrode bars and a pair of opposed depending members for applying pressure to IPG strips located in troughs of the tray, the opposed depending members being spaced inwardly of the electrode bars relative to the sides of the lid.

2. An apparatus as claimed in claim 1, wherein the base defines a frame and the tray is separable from the frame.

3. An apparatus as claimed in claim 1, wherein the frame is generally rectangular and defines four upstanding walls and an inwardly directed flange for supporting the tray relative to the frame.

4. An apparatus as claimed in claim 1, wherein the frame is open such that the underside of the base of the tray is exposed during use.

5. An apparatus as claimed in claim 1, wherein the base defines a frame and the tray is integral with the frame.

6. An apparatus for receiving a tray as claimed in claim 1, wherein the depending electrode bars are mounted on biasing means.

7. An apparatus as claimed in claim 1, wherein the depending members are mounted on biasing.

8. An apparatus as claimed in claim 1, wherein the lid defines an aperture for the ingress of an insulating fluid and a seal is defined between the lid and the base.

9. An apparatus as claimed in claim 1, wherein the lower edge of the depending electrode bars are crenellated and the electrode bars define a pair of individually addressable electrodes for each of the troughs in the tray.

10. An apparatus as claimed in claim 6, wherein the biasing means comprise springs.

11. An apparatus as claimed in claim 7, wherein the biasing means comprise springs.

12. An apparatus for performing an electrophoresis experiment comprising:
a base incorporating a tray, said tray defining a plurality of parallel troughs for receiving gel strips; and
a lid defining a top and depending side walls and end walls, the lid being configured to fit over the base characterised in that the lid defines at least one opposed pair of depending electrode bars mounted on biasing means and a pair of opposed depending members for applying pressure to gel strips located in troughs of the tray, spaced inwardly of the electrode bars relative to the end walls of the lid.

13. An apparatus as claimed in claim 12, wherein the base defines a frame and the tray is separable from the frame.

14. An apparatus as claimed in claim 13, wherein the frame is generally rectangular and defines four upstanding walls and an inwardly directed flange for supporting the tray relative to the frame.

15. An apparatus as claimed in claim 14, wherein the lid defines an aperture for the ingress of oil or the like and wherein a seal is defined between the lid and the base.

16. An apparatus as claimed in claim 12, wherein the lower edge of the depending electrode bars are crenellated and the electrode bars define individually addressable electrodes for each of the troughs in the tray.

17. An apparatus for performing an electrophoresis experiment comprising:
a base frame for receiving a tray;
a tray defining a plurality of parallel troughs for receiving gel strips; and
a lid defining a top and depending side walls and end walls, the lid being configured to fit over the base frame characterised in that the lid defines at least one opposed pair of depending electrode bars, said electrode bars defining a plurality of electrodes, with electrodes disposed at each end of the trough comprising a pair of electrodes for supplying voltage along the trough, each pair of electrodes being independent from the other pairs of electrodes, such that different voltages may be applied along each trough, the electrodes being mounted on biasing means for ensuring positive downwards pressure on gel strips located in the troughs, and wherein the lid further defines a pair of opposed depending members for applying pressure to gel strips located in troughs of the tray, the depending members being spaced inwardly of the electrode bars relative to the end walls of the lid.

18. An apparatus as claimed in claim 17, wherein the lid defines an aperture for the ingress of an insulating fluid and a seal is defined between the lid and the base.

19. An apparatus as claimed in claim 17, wherein the lower edges of the depending electrode bars are crenellated.
